(19) United States
(12) Patent Application Publication
(10) Pub. No.: US 2009/0252543 A1
(43) Pub. Date: Oct. 8, 2009

(54) METHOD FOR CONDUCTING WATER TRANSFER PRINTING PROCESS ON BAKING TRAY

(76) Inventor: Yu Tzu Wang, Taipei (TW)

Correspondence Address: Wang Law Firm, Inc., 4989 Peachtree Parkway,, Suite 200, Norcross, GA, 30092, US

(21) Appl. No.: 12/061,121

(22) Filed: Apr. 2, 2008

(51) Int. Cl. G03G 15/20

(52) U.S. Cl. 399/335

(57) ABSTRACT

A method for conducting a water transfer printing process on a baking tray comprises steps of: cleaning an inner object-supporting and an outer surface of the baking tray and forming a crystalline protective film thereon; oven-drying the cleaned baking tray; spray-coating the inner object-supporting surface with a silicone and baking the silicone; spray-coating the outter surface with a primer and baking the primer; transferring a pattern onto the outer surface by water transfer printing, wherein a water flow is used to flatten a transfer paper attached to the baking tray; over-drying residual water left from the water transfer printing process; spray-coating the outer surface with a silicone-based transparent varnish and baking the transparent varnish. The present invention allows a baking tray having an irregular shape to be provided with a pattern thereon and thus beutifies the baking tray.

### BACKGROUND OF THE INVENTION

1. Technical Field

The present invention relates to a method for forming a pattern on a surface of a baking tray and, more particularly, to a method of using a water transfer printing process to form a pattern on a surface of a baking tray having a small thickness and an irregular shape.

2. Description of Related Art

Metal cooking pots and pans decorated with patterns on outer surfaces thereof can be found on the market. These patterns are formed, for example, by bake coating or with heat transfer stickers, so as to adapt to the high-temperature environment in which the pots are pans are used. On the other hand, baking trays (boxes) for making cakes and pastries are usually not colored and available only in their original metal colors.

The baking trays are not decorated with patterns because of thicknesses thereof. A baking tray is normally made of a material having a thickness between 0.5 and 1.0 mm whereas a cooking pot or pan generally has a thickness of 2.5 mm or above. Now that the bake coating or heat transfer techniques for coloring, or transferring patterns onto, cooking pots and pans have operating temperatures higher than 100° C., which are way beyond the 300° C. thermal limit of baking trays, the already-formed baking trays will deform if those techniques are applied thereto. Another reason why the baking trays are not formed with patterns is that the baking trays have irregular contours for providing a variety of cake shapes. The variously contoured surfaces of the baking trays make it more difficult to transfer or attach patterns thereon and increase the failure rate of such operations. As a result, there are currently no baking trays coated or attached with patterns.

### BRIEF SUMMARY OF THE INVENTION

In view of the fact that the problems associated with providing a baking tray with a surface pattern have not been solved, the present invention aims to provide a method for forming a pattern on a surface of a baking tray and, more particularly, a method of using a water transfer printing process to form a pattern on a baking tray, so that a baking tray having an irregular shape and a smaller thickness than a thickness of a common cooking pot or pan can be decorated with a pattern and thereby beautified.

To achieve this end, the present invention provides a method for conducting the water transfer printing process on a baking tray comprising steps of: cleaning an inner object-supporting surface and an outer surface of the baking tray and forming a crystalline protective film thereon; oven-drying the cleaned baking tray; spray-coating the inner object-supporting surface of the baking tray with a silicone and baking the silicone on the inner object-supporting surface of the baking tray at 200 to 300° C. for 10 to 15 minutes; spray-coating the outer surface of the baking tray with a primer and baking the primer on the outer surface of the baking tray at 180 to 200° C. for 5 to 6 minutes; transferring a pattern onto the outer surface of the baking tray by water transfer printing, wherein a water flow is used to flatten a transfer paper attached to the baking tray so that the transfer paper is totally flat on the baking tray; oven-drying residual water left from the water transfer printing process at 120° C. for 5 to 10 minutes; spray-coating the outer surface of the baking tray with a silicon-based transparent varnish and baking the transparent varnish on the outer surface of the baking tray at 280° C. for 10 to 15 minutes.

In the foregoing method for conducting the water transfer printing process on a bake tray, the operating temperature of each step is below 300° C., so that a decorative pattern can be formed on the baking tray without deforming the baking tray. In addition, using the water transfer printing process, the present invention can successfully decorate a baking tray having an irregular shape with a flat pattern. Thus, the method for conducting the water transfer printing process on a baking tray according to the present invention increases the esthetics as well as the value of the baking tray.

### BRIEF DESCRIPTION OF THE SEVERAL VIEWS OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 is a flow chart of a method for conducting the water transfer printing process on a baking tray according to a preferred embodiment of the present invention; and

FIGS. 2 and 3 are perspective views of baking trays made by the method of the present invention, wherein water transfer printed patterns are formed on outer surfaces of the baking trays.

### DETAILED DESCRIPTION OF THE INVENTION

Generally, a baking tray can be formed by two approaches: post-coating (i.e., coating is performed after a baking tray is formed) and pre-coating (i.e., a flat plate is bake-coated before it is stretch-formed into a baking tray). A baking tray decorated by a water transfer printing process of the present invention is formed by the post-coating approach.

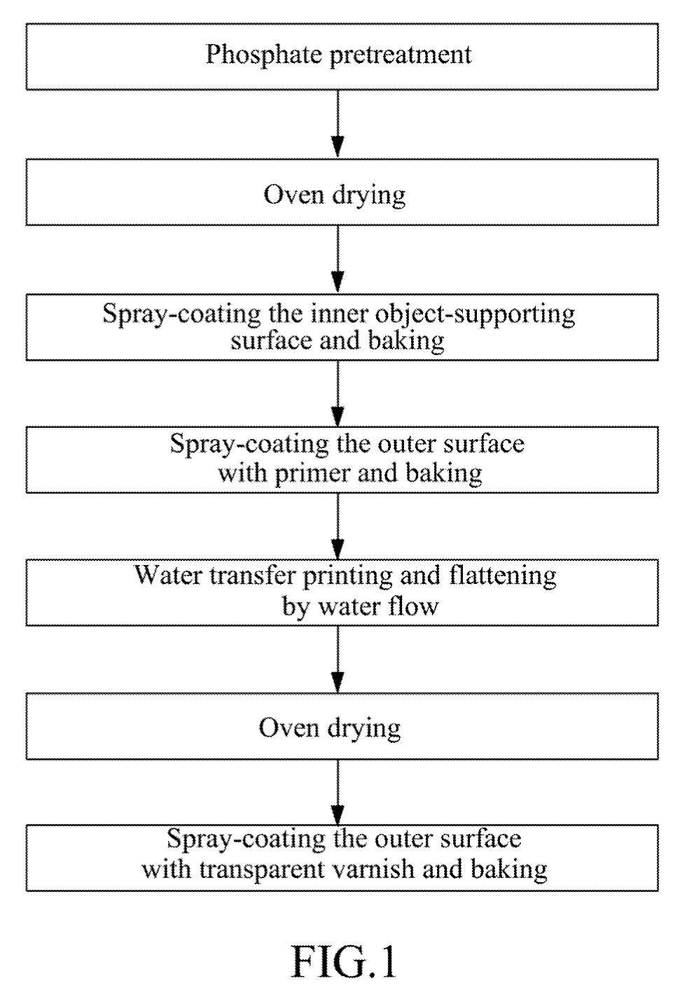

Referring to FIG. 1 for a flow chart of the method for conducting the water transfer printing process on a baking tray according to a preferred embodiment of the present invention, wherein the method comprises the following steps:

Phosphate Pretreatment

A formed and un-painted baking tray is cleaned with an alkaline cleanser to remove residual metal-processing machine oil from an inner object-supporting surface and an outer surface of the baking tray. The surfaces are then phosphatized by a chemical, such as a phosphate, to form a crystalline protective film thereon.

Oven Drying

The cleaned baking tray is put in a drying oven to remove water thereon at 150 to 200° C. (preferably 180° C.) for 10 to 15 minutes (preferably 15 minutes).

Spray-Coating the Inner Object-Supporting Surface and Baking

The inner object-supporting surface of the baking tray is spray-coated with a silicone and then baked at 200 to 300° C. (preferably 280° C.) for 10 to 15 minutes to solidify the silicone, which provides the inner object-supporting surface of the baking tray with a non-stick effect when in use.

Spray-Coating the Outer Surface with Primer and Baking

The outer surface of the baking tray is spray-coated with an appropriate color paint according to features of a desired pattern to be transfer printed on the outer surface. The baking tray is then baked at 180 to 200° C. (preferably 200° C.) for 5 to 6 minutes, so that the paint on the outer surface of the baking tray is semi-solidified.

Water Transfer Printing and Flattening by Water Flow

A pattern is transferred onto the outer surface of the baking tray by a water transfer printing process, wherein a transfer paper attached to the baking tray is flattened by a water flow, so that the transfer paper is totally flat on the baking tray.

Oven Drying

The baking tray is oven-dried at 120° C. for 5 to 10 minutes to remove residual water left from the water transfer printing process.

Spray-Coating the Outer Surface with Transparent Varnish and Baking

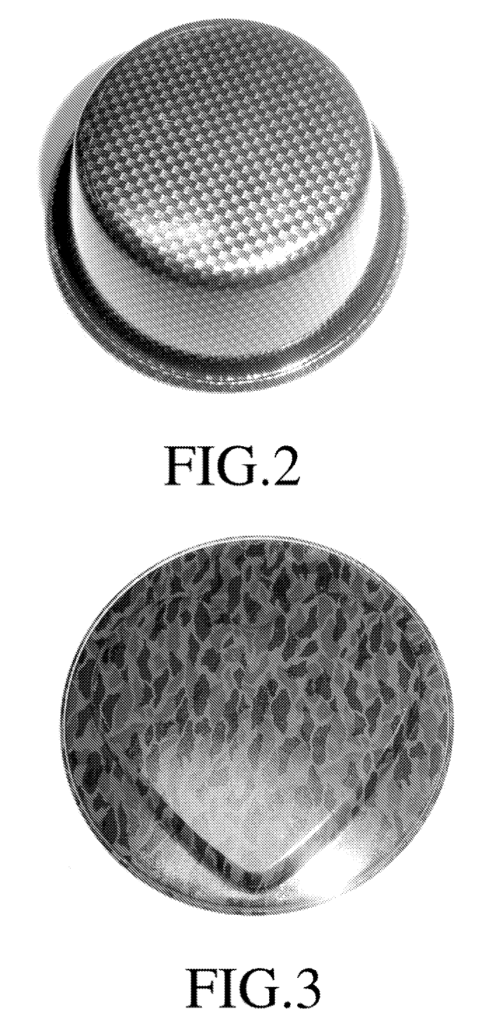

In order to protect the water transfer printed pattern, the outer surface of the baking surface is spray-coated with a silicon-based transparent varnish and then baking at 280° C. for 10 to 15 minutes, so that the transparent varnish on the outer surface of the baking tray is solidified and the pattern thus formed on the outer surface of the baking tray (as shown in FIGS. 2 and 3) can stand the operating temperature of the baking tray, i.e., 280° C. or below.

By the foregoing steps, a baking tray having an irregular shape can be provided with a pattern and a color on a surface thereof.

In the preferred embodiment of the present invention described above, the pattern is applied with the water transfer printing process only on the outer surface of the baking tray. However, the same steps can also be applied to provide the inner object-supporting surface of the baking tray with a pattern by water transfer printing, as long as the inner object-supporting surface of the baking tray is not disadvantageously affected in terms of food safety.

The present invention has been described with the preferred embodiment thereof and it is understood that the embodiments are not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

1. A method for conducting a water transfer printing process on a baking tray, comprising steps of:
cleaning an inner object-supporting surface and an outer surface of the baking tray, and forming a crystalline protective film thereon;
oven-drying the cleaned baking tray at 150 to 200° C. for 10 to 15 minutes; spray-coating the inner object-supporting surface of the baking tray with a non-stick coating material, and baking the non-stick coating material at 200 to 300° C. for 10 to 15 minutes;
spray-coating the outer surface of the baking tray with a primer, and baking the primer at 180 to 200° C. for 5 to 6 minutes;
transferring a pattern onto the outer surface of the baking tray by the water transfer printing process, wherein a water flow is used to flatten a transfer paper attached to the baking tray so that the transfer paper is totally flat on the baking tray;
oven-drying residual water left from the water transfer printing process at 120° C. for 5 to 10 minutes; and
spray-coating the outer surface of the baking tray with a silicon-based transparent varnish, and baking the transparent varnish at 280° C. for 10 to 15 minutes.

2. The method for conducting the water transfer printing process on the baking tray as claimed in claim 1, wherein the step of cleaning the inner object-supporting surface and the outer surface of the baking tray and forming the crystalline protective film comprises: cleaning said surfaces with an alkaline cleanser to remove therefrom residual metal-processing machine oil; and phosphatizing said surfaces with a phosphate so as to form the crystalline protective film thereon.

3. The method for conducting the water transfer printing process on the baking tray as claimed in claim 1, wherein the cleaned baking tray is oven-dried at 180° C. for 15 minutes.

4. The method for conducting the water transfer printing process on the baking tray as claimed in claim 1, wherein the non-stick coating material is baked at 280° C.

5. The method for conducting the water transfer printing process on the baking tray as claimed in claim 1, wherein the primer on the outer surface of the baking tray is baked at 200° C.

6. The method for conducting the water transfer printing process on the baking tray as claimed in claim 1, wherein the non-stick coating material spray-coated on the inner object-supporting surface of the baking tray is silicone.
